(19) United States
(12) Patent Application Publication
(10) Pub. No.: US 2010/0263048 A1
(43) Pub. Date: Oct. 14, 2010

(54) MALWARE PREVENTION METHOD AND SYSTEM IN A PEER-TO-PEER ENVIRONMENT

(76) Inventors: Chih-Jen Chang, Hsinchu County (TW); Shih-Wei Chien, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/422,989

(22) Filed: Apr. 14, 2009

(51) Int. Cl. G06F 21/00; G06F 12/14; G06F 17/30

(52) U.S. Cl. 726/23; 707/E17.01; 707/E17.032

(57) ABSTRACT

A computer-implemented method and system for malware prevention in a peer-to-peer (P2P) environment are disclosed. Specifically, one implementation of the embodiment sets forth a method, which includes the operations of obtaining a meta information of a data, prior to initiating downloading of the data, sending the meta information to a server, and initiating downloading of the data after having received confirmation from the server that the meta information is free from being associated with any known malware.

### BACKGROUND OF THE INVENTION

### Description of the Related Art

The rise of personal computing devices as a business tool and a home appliance, together with the growth of the Internet as a means for providing information to such computing devices, has changed the way people live and work. Information in the form of data files and executable software programs is regularly exchanged among interconnected computing devices and data storage devices. One popular data distribution network is a peer-to-peer (P2P) network, which utilizes diverse connectivity among participants in the network and the cumulatively bandwidth of these network participants. P2P networks can be used for media streaming, telephony, and file sharing. Some examples of P2P applications for the P2P networks include eDonkey2000, Bit Torrent, and Gnutella. However, exchanging data via the P2P networks is vulnerable to malware attacks, since the computing device requesting for data generally has minimal knowledge of the P2P network participants. If just one of the network participants having the requested data is infected by malware, then the requesting computing device is likely to receive the requested data along with the malware.

FIG. 1A illustrates a conventional P2P network 100. The P2P network 100 typically includes a requesting computer 102 requesting for a data file. The requested data file may be stored in multiple computing devices 104, 106, and 108 in different locations.

To find the entire data file in the different computing devices 104, 106, and 108, in conjunction with FIG. 1A, FIG. 1B is a flow chart illustrating a conventional file distribution process used in a P2P network. In operation 120, the requesting computer 102 first obtains the meta information of the data file from the Internet. The meta information of the data file contains information such as the name of the data file, size of the data file, and the hash values of the different parts of the data file. The meta information may be obtained from on-line forums or websites designed specifically for P2P file distribution. After obtaining the meta information, the requesting computer 102 may prepare to download the data file from the network in operation 122. For example, the requesting computer 102 may use the meta information to check with the computing devices 104,106, and 108 in the P2P network for the relevant information of the data file, such as the locations of the data file and portions of the data file in the locations. Upon receiving the meta information from the requesting computer 102, each of the computing devices 104,106, and 108 may then respond to the requesting computer 102 the location and the portion of the data file that each of the computing devices 104, 106, and 108 currently owns. If the requesting computer 102 also owns a certain portion of the data file, it may also inform the computing devices 104,106, and 108 in the P2P network. In operation 124, when the relevant information is obtained from the servers or participants, the downloading of the file may begin. After completing the download, the downloaded data file may be scanned for malware by the requesting computer 102 in operation 126.

One shortcoming associated with the conventional file distribution process is that someone may post certain meta information in the on-line forums or the P2P file distribution websites claiming it to be for a popular file, even though the meta information is for certain malware. In other words, the requesting computer 102 is susceptible to malware infection when it downloads the file according to the meta information from such on-line forums or websites. Another shortcoming is associated with the passive approach to scan the data file after having downloaded it and possibly having already infected the requesting computer 102. Thus, precious resources may be wasted on downloading an infected data file, resulting in certain malware attack that may not be completely reversible.

As the foregoing illustrates, what is needed is a malware prevention method and system to address at least the problems set forth above.

### SUMMARY OF THE INVENTION

A computer-implemented method and system for malware prevention in a peer-to-peer (P2P) environment are disclosed. Specifically, one implementation of the embodiment sets forth a method, which includes the operations of obtaining a meta information of a data, prior to initiating downloading of the data, sending the meta information to a server, and initiating downloading of the data after having received confirmation from the server that the meta information is free from being associated with any known malware.

At least one advantage of the disclosed method and apparatus is to prevent a data file containing malicious codes from reaching a client computer, so that the client computer may be able to determine early if the requested data file may be infected with hidden malware and therefore saving precious download time.

### BRIEF DESCRIPTION OF THE DRAWINGS

So that the manner in which the above recited features of the embodiment can be understood in detail, a more particular description of the invention, briefly summarized above, may be had by reference to implementations, some of which are illustrated in the appended drawings. It is to be noted, however, that the appended drawings illustrate only typical implementations of this invention and are therefore not to be considered limiting of its scope, for the invention may admit to other equally effective implementations.

FIG. 1A illustrates a conventional peer-to-peer network;

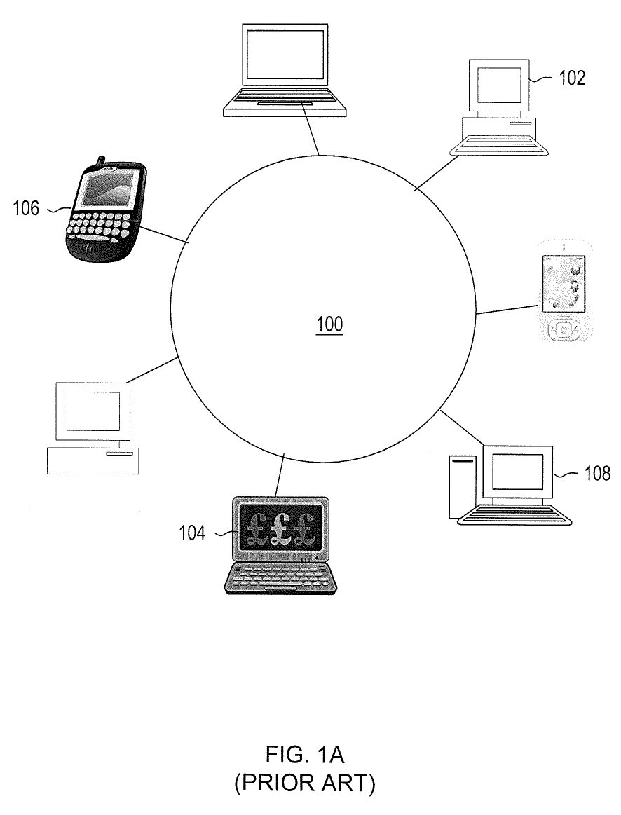

FIG. 1B is a flow chart illustrating a conventional file distribution process used in a peer-to-peer network;

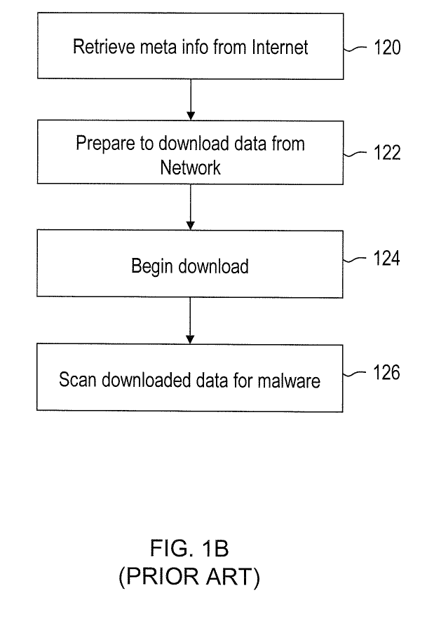

FIG. 2 illustrates a data distribution network according to one embodiment of the present invention;

FIG. 3A is an example of a meta information of a data file, according to one embodiment of the present invention;

FIG. 3B is a flow chart illustrating a process for comparing and storing the meta information of a data by a server, according to one embodiment of the present invention;

FIG. 4 is a flow chart illustrating a data distribution process used in a data distribution network, according to one embodiment of the present invention; and

FIG. 5 is a schematic diagram of a computing system 500 configured to manage data downloaded from a data distribution network, according to one embodiment of the present invention.

### DETAILED DESCRIPTION

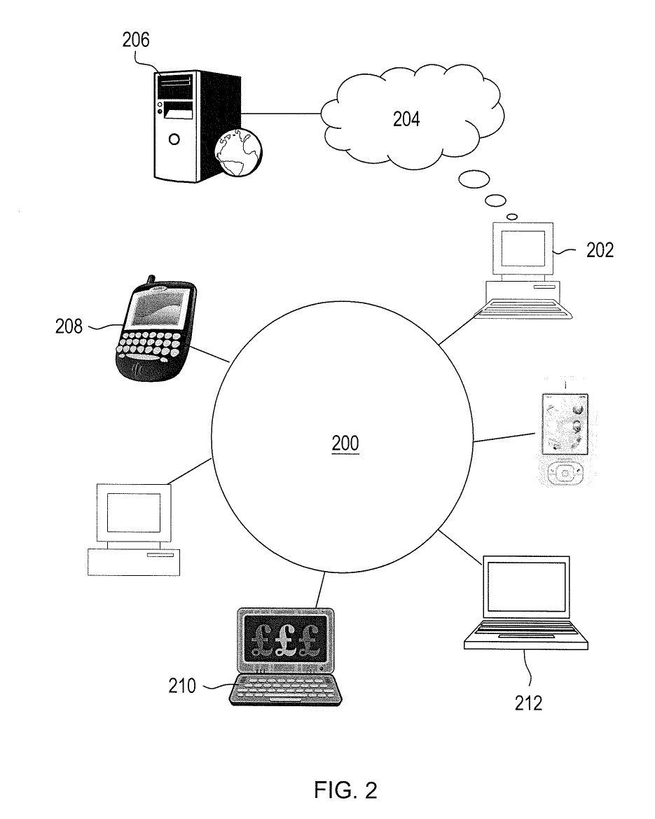

FIG. 2 illustrates a data distribution network according to one embodiment of the present invention. The data distribution network 200 includes a data requester 202 and multiple data distributors 208, 210, and 212. The data requester 202 and the data distributors 208, 210, and 212 may be any computing device with networking capabilities such as, without limitation, a desktop computer, a laptop computer, a mobile phone, a Personal Digital Assistance (PDA), and a gaming device. A server 206 may be separately connected to the data requester 202 through a computer network 204, such as the Internet. The server 206 has access to a malware database, which is configured in some implementations to store known malware and the meta information of the data that has been infected by the known malware. The data requester 202 may download data from the multiple data distributors 208, 210, and 212 through the data distribution network 200. In one implementation, the data distribution network 200 is a P2P network. To prevent malware from infecting the data requester 202, before initiating the downloading of the requested data, one approach is to obtain the meta information of the requested data and compare it against the meta information that has been tagged to be associated with known malware in the malware database. If the comparison yields a match, then the requested data may be determined to have been infected by malware and any attempt to download the requested data is suspended. In some implementations, the server 206 is configured to receive the meta information from the data requester 202 and compare it against the entries in the malware database.

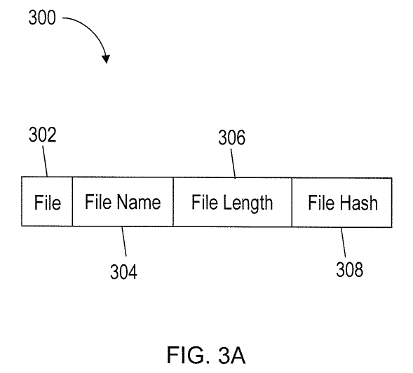

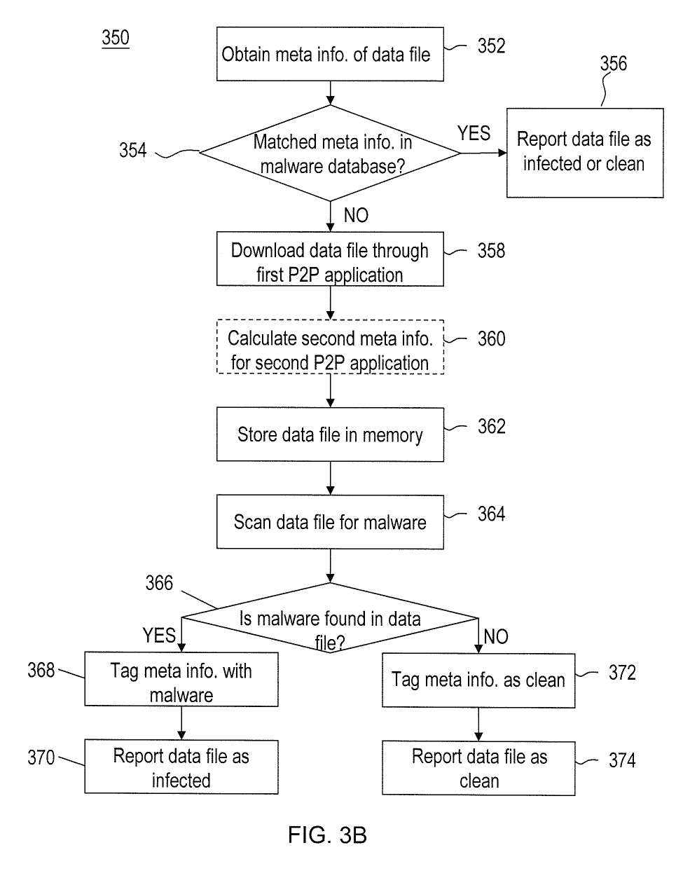

To set up the malware database, the meta information associated with known malware and also with data that may be distributed in the data distribution network 200 may be predetermined and stored in the malware database accessible by the server 206. The meta information may include categories such as file type, file name, file length, and file hash associated with the data. Each category may be given a value by the different P2P applications. FIG. 3A is an example of a meta information 300 of a data file, according to one embodiment of the present invention. The meta information 300 may include a file category 302, a file name category 304, a file length category 306, and a file hash category 308. A P2P application may extract the file category 302, the file name category 304, and the file length category 306 from the data file using the set of values recognizable by the application. In some implementations, the P2P application generates a value based on the content of the requested data and puts the value in the file hash category 308.

In conjunction with FIG. 2, FIG. 3B is a flow chart illustrating a process 350 for comparing and storing the meta information of a data by a server, according to one embodiment of the present invention. As an example illustration, suppose the data requester 202 sends the meta information of a data file that it is intending to download. In operation 352, the server 206 obtains the meta information of the data file. It should be noted that the server 206 may actively search for and obtain meta information from another source, such as, without limitation, a web server on the Internet that is configured to host the meta information or any device having the meta information. In operation 354, the server 206 then determines whether the meta information has already been checked and is stored in the malware database. In some implementations, the file hash category of the meta information for the data file is compared to the file hash category of the meta information that is stored in the malware database. If the comparison result indicates a match, then the server 206 reports the comparison result to the data requester 202 in operation 356.

On the other hand, if there is no match, then the server 206 may download the data file through a first P2P application in operation 358. In operation 360, a second meta information of the data file may be optionally calculated for a second P2P application and store in a database storage unit in a memory. In operation 362, the server 206 stores the downloaded data file in a memory unit, e.g. a temporary storage unit, accessible by the server 206 and scans the data file for malware in operation 364. In some implementations, during the downloading of the data file, the server 206 may periodically scan portions of the data file that has been downloaded and stored in the accessible memory unit for malware. In operation 366, the server 206 determines whether the data file is infected by a known malware. If malware is found in the data file, then in operation 368, the server 206 tags all the meta informations for different P2P applications with the identified malware in the malware database. In one implementation, the tagged meta information is stored in the memory unit. The memory unit may be the database storage unit. The server 206 also reports to the data requester 202 that the data file has been infected in operation 370. If no malware is found in the data file, then in some implementations, the meta information of the data file is also recorded in the malware database as “clean meta information.” In operation 374, the server 206 reports to the data requester 202 that the data file is clean. Any meta information is considered clean when it is free from being associated with any known malware.

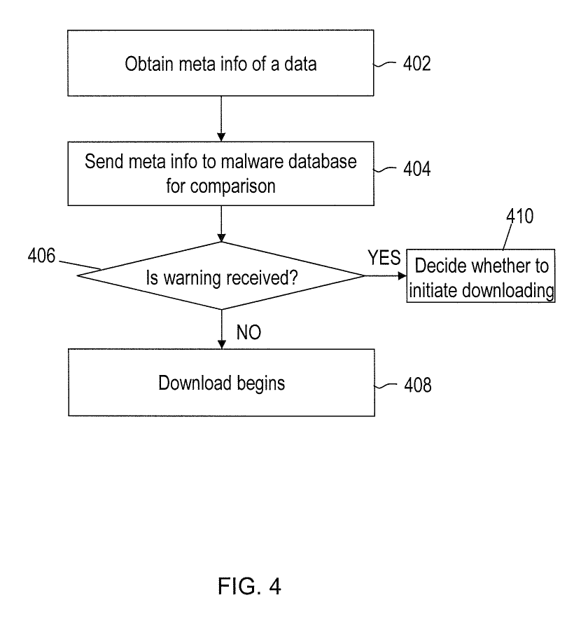

In conjunction with FIG. 2, FIG. 4 is a flow chart illustrating a data distribution process used in a data distribution network 200, according to one embodiment of the present invention. After the data requester 202 decides on certain data, such as a data file, that it is interested in downloading, in operation 402, the data requester 202 obtains the meta information of the interested data from a meta information source. In some implementations, the meta information source may include on-line forums, P2P related websites, memory sticks, memory cards, and external hard drives. In operation 404, the data requester 202 sends the meta information of the interested data to the server 206 to be compared against the meta information stored in the malware database. In operation 406, the data requester 202 determines if the received report from the server 206 is construed as a warning (e.g., the interested data is infected). In operation 408, if no warning message is received, then the data requester 202 determines that the interested data is clean and begins the downloading process. On the other hand, if the interested data is deemed to have been infected, then in operation 410, the data requester 202 may decide to either stop or still initiate the download. In some implementations, the data requester 202 may send portions of the interested data that has been downloaded during the downloading process to the server 206 for further comparison against the meta information stored in the malware database. If the interested data is deemed to be infected, the data requester 202 may decide to either stop or continue with the download. In other implementations, if the download for the interested data is complete, further warning may be provided by the server 206 to the data requester 202, and the data requester 202 then may decide either to delete or store the interested data.

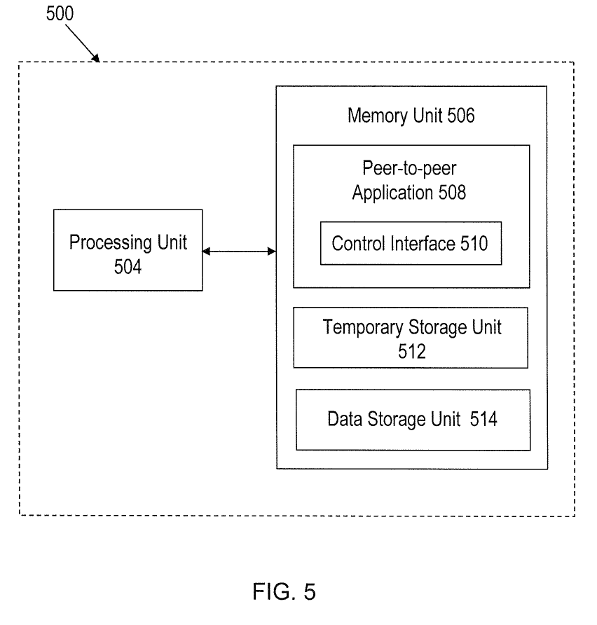

FIG. 5 is a schematic diagram of a computing device 500 configured to manage data downloaded from a data distribution network, according to one embodiment of the present invention. In one implementation, the data requester 202 of FIG. 2 corresponds to the computing device 500. The computing device 500 includes a processing unit 504 and a memory unit 506. The processing unit 504 is configured to execute the instructions of a P2P application 508 to manage downloading of data from the data distribution network. The processing unit 504 is further configured to maintain a connection with a server through a computer network. The memory unit 506 includes the P2P application 508 for retrieving data from different sources within the data distribution network, a control interface 510, which is coupled to the P2P application 508, for configuring the application, a temporary storage unit 512 for temporarily storing the downloaded data during the downloading process, and a data storage unit 514 for storing the completely downloaded data. In one implementation, the control interface 510 further includes a user interface in which instructions for downloading the data may be initiated. In some implementations, the temporary storage unit 512 and the data storage unit 514 may be identical. Alternatively, the data storage unit 514 may be external but coupled to the computing device 500.

One embodiment of the present invention is implemented as a program product. The program(s) of the program product defines functions of the implementations (including the operations described herein) and can be contained on a variety of machine-readable storage media. Illustrative machine-readable storage media include, but are not limited to: (i) non-writable storage media (e.g., CD-ROM disks readable by a CD-ROM drive, DVD disks readable by a DVD drive, or read-only memory devices within a network device such as Read Only Memory chips or any type of solid-state non-volatile semiconductor memory) on which information is permanently stored; (ii) writable storage media (e.g., flash memory or any type of solid-state random-access semiconductor memory) on which alterable information is stored. Such machine-readable storage media, when carrying machine-readable instructions that direct the functions of the embodiment, are implementations of the embodiment. Other media include communications media through which information is conveyed to a network device, such as through a computer or telephone network, including wireless communications networks. The latter implementation specifically includes transmitting information to/from the Internet and other networks. Such communications media, when carrying machine-readable instructions that direct the functions of the embodiment, are implementations of the embodiment.

The above description illustrates various implementations of the embodiment along with examples of how aspects of the embodiment may be implemented. The above examples, implementations, and drawings should not be deemed to be the only implementations, and are presented to illustrate the flexibility and advantages of the embodiment as defined by the following claims.

We claim:

1. A computer-implemented method for malware prevention in a peer-to-peer (P2P) environment, the method comprises:
obtaining a meta information of a data;
prior to initiating downloading of the data, sending the meta information to a server; and
initiating downloading of the data after having received confirmation from the server that the meta information is free from being associated with any known malware.

2. The computer-implemented method of claim 1, wherein the meta information includes one or more of a file category, a file name category, a file length category, and a file hash category.

3. The computer-implemented method of claim 2, wherein the meta information of the data varies among different P2P applications.

4. A computing system configured to prevent malware distribution in a peer-to-peer environment, the computer system comprises:
a memory unit, and
a processing unit, wherein the processing unit is configured to:
obtain a meta information of a data;
prior to initiating downloading of the data, send the meta information to a server; and
initiate downloading of the data after having received confirmation from the server that the meta information is free from being associated with any known malware.

5. The computing system of claim 4, wherein the processing unit is further configured to maintain a connection with the server through a computer network.

6. The computing system of claim 4, wherein the meta information may include a file category, a file name category, a file length category, and a file hash category.

7. The computing system of claim 6, wherein the file hash category is a value given by the different P2P applications based on the content.

8. A system residing on a network coupled to a peer-to-peer (P2P) environment configured to manage a malware database, the computer system comprises:
obtaining a first meta information of a data;
comparing the first meta information of the data to meta information of known malwares in the malware database;
tagging the first meta information if compared to a known malware; and
storing the tagged first meta information into memory.

9. The system of claim 8, wherein the memory further comprises a database storage unit for storing the tagged meta information of a data.

10. The method of claim 8, further comprising downloading the data if the first meta information of the data does not match the meta information of known malwares.

11. The method of claim 10, further comprising scanning the downloaded data for malware.

12. The method of claim 11, further comprising calculating a second meta information of the downloaded data for a second P2P application and storing the meta information into the database storage unit.

13. The method of claim 10, wherein the malware database further comprising the meta information of known malware and the meta information of data distributed in the P2P environment.

14. The method of claim 10, wherein the data is downloaded by using P2P application.

15. A machine-readable medium containing a sequence of instructions for malware prevention in a peer-to-peer environment, which when executed by a processing unit in a computing system, causes the processing unit to:
obtaining a meta information of a data;
prior to initiating downloading of the data, sending the meta information to a server; and
initiating downloading of the data after having received confirmation from the server that the meta information is free from being associated with any known malware.

16. The machine-readable medium of claim 15, further containing a sequence of instructions, which when executed by the processing unit, causes the processing unit to download data from different sources within a peer-to-peer environment.
